(19) United States
(12) Patent Application Publication
(10) Pub. No.: US 2026/0281947 A1
(43) Pub. Date: Sep. 17, 2026

(54) RESTRICTION ON TRANSMISSION OF RADIO WAVE IN FREQUENCY BAND USED FOR RADIO COMMUNICATION VIA SATELLITE

(71) Applicant: Rakuten Mobile, Inc., Tokyo (JP)

(72) Inventors: Makoto ONO, Tokyo (JP); Bingxuan ZHAO, Tokyo (JP); Warangrat WIRIYA, Tokyo (JP); Ryusuke UTSUNOMIYA, Tokyo (JP); Hyungmin HA, Tokyo (JP); Ryoji OSAKA, Tokyo (JP)

(21) Appl. No.: 19/235,607

(22) Filed: Jun. 12, 2025

(30) Foreign Application Priority Data
Mar. 13, 2025 (JP) 2025-040702

(51) Int. Cl. H04W 64/00; H04W 8/18

(52) U.S. Cl. CPC H04W 64/00; H04W 8/18

(57) ABSTRACT

A UE estimates a location of the UE without transmitting radio waves in a frequency band used for wireless communication via a satellite. The UE determines whether to restrict transmission of radio waves in the frequency band used for wireless communication via the satellite based on whether or not the estimated location is within an area in which wireless communication via the satellite is permitted.

### CROSS-REFERENCE TO RELATED APPLICATION

This application claims priority to JP 2025-040702, filed on Mar. 13, 2025; the entire contents of which are incorporated herein by reference.

### FIELD

The present disclosure relates to a restriction on transmission of radio wave in frequency band used for radio communication via satellite.

### BACKGROUND

In WO 2022/254744 A1, there is described a communication control apparatus which can effectively manage a connection authority of a communication device to a wireless communication system in which a terrestrial communication system and a non-terrestrial communication system coexist.

The information disclosed in this background section is only for enhancement of understanding of the general background of the disclosure and should not be taken as an acknowledgement or any form of suggestion that this information forms the prior art already known to a person skilled in the art.

### SUMMARY

In recent years, wireless communication via a satellite using the same protocol as that of wireless communication via a ground antenna has been considered.

Management of radio waves is carried out separately in each region, for example, in each country, and hence there is a possibility that a part or all of frequency bands used in wireless communication via a satellite 150, which covers at least a part of a region 140a illustrated in FIG. 1, may overlap frequency bands used in wireless communication performed via a ground antenna 146b, which covers at least a part of a region 140b adjacent to the region 140a.

Normally, as illustrated in FIG. 1, even when a UE 110ac capable of using a wireless communication service provided in the region 140a happens to be located in the region 140b, the UE 110ac is located outside the range of a cell 148c, which is a communication range (coverage) of the satellite 150, and therefore wireless communication performed via the ground antenna 146b (for example, wireless communication performed by the UE 110b) is not affected by the UE 110ac.

However, as illustrated in FIG. 2, there are cases in which a broadcast signal transmitted from the satellite 150 reaches the region 140b. In the situation, when the UE 110ac transmits radio waves in response to the broadcast signal, those radio waves may interfere with the radio waves relating to the wireless communication performed via the ground antenna 146b.

Consideration is being given to restricting the UE 110ac from performing wireless communication via the satellite 150 by refusing authentication of the UE 110ac at a core network or a base station. However, even when such a method is adopted, radio waves for authentication are still transmitted from the UE 110ac.

The present disclosure has been made in view of the above-mentioned circumstances, and has an object to provide a terminal, a transmission control method, and an information storage medium with which radio wave interference caused by radio waves in a frequency band used for wireless communication via a satellite being transmitted from the terminal can be prevented.

A terminal according to at least one embodiment of the present disclosure is a terminal which performs wireless communication via a satellite, and executes a location estimation process and a transmission restriction determination process. In the location estimation process, a location of the terminal is estimated without transmitting radio waves in a frequency band used for wireless communication via the satellite. In the transmission restriction determination process, whether to restrict transmission of radio waves in the frequency band used for wireless communication via the satellite is determined based on whether the estimated location is within an area in which wireless communication via the satellite is permitted.

Further, a transmission control method according to at least one embodiment of the present disclosure includes estimating, by a terminal which performs wireless communication via a satellite, a location of the terminal without transmitting radio waves in a frequency band used for wireless communication via the satellite. The transmission control method also includes determining, by the terminal, whether to restrict transmission of radio waves in the frequency band used for wireless communication via the satellite based on whether the estimated location is within an area in which wireless communication via the satellite is permitted.

Further, an information storage medium according to at least one embodiment of the present disclosure is a non-transitory computer-readable information storage medium having stored thereon a program to be executed by a computer, which is a terminal. The program causes the terminal to estimate a location of the terminal which performs wireless communication via a satellite, without transmitting radio waves in a frequency band used for wireless communication via the satellite. The program also causes the terminal to determine whether to restrict transmission of radio waves in the frequency band used for wireless communication via the satellite based on whether or not the estimated location is within an area in which wireless communication via the satellite is permitted.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a diagram for illustrating an example of an implementation environment in at least one embodiment of the present disclosure.

FIG. 2 is a diagram for illustrating an example of an implementation environment in the at least one embodiment of the present disclosure.

FIG. 3 is a functional block diagram for illustrating an example of functions implemented by a UE in the at least one embodiment of the present disclosure.

FIG. 4 is a flowchart for illustrating an example of a flow of processes performed by a UE in the at least one embodiment of the present disclosure.

FIG. 5 is a functional block diagram for illustrating an example of functions implemented by a UE in the at least one embodiment of the present disclosure.

FIG. 6 is a table for showing an example of restriction necessity data.

FIG. 7 is a functional block diagram for illustrating an example of functions implemented by a UE in the at least one embodiment of the present disclosure.

FIG. 8 is a table for showing an example of usable PLMN data.

FIG. 9 is a flowchart for illustrating an example of a flow of processes performed by a UE in the at least one embodiment of the present disclosure.

FIG. 10 is a functional block diagram for illustrating an example of functions implemented by a UE in the at least one embodiment of the present disclosure.

FIG. 11 is a functional block diagram for illustrating an example of functions implemented by a UE in the at least one embodiment of the present disclosure.

FIG. 12 is a flowchart for illustrating an example of a flow of processes performed by a UE in the at least one embodiment of the present disclosure.

FIG. 13 is a flowchart for illustrating an example of a flow of processes performed by a UE in the at least one embodiment of the present disclosure.

FIG. 14 is a diagram of example components of a device which is a UE.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

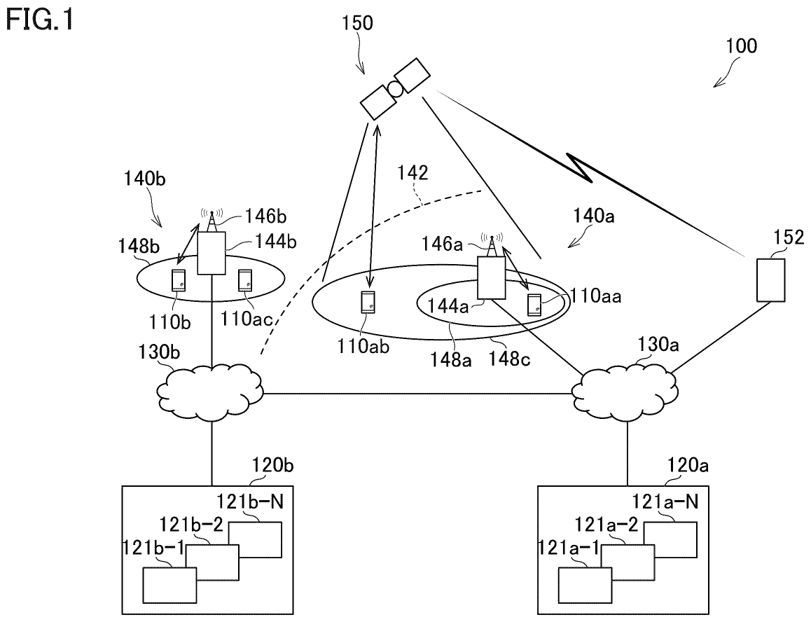

FIG. 1 is a diagram of an example of implementation environment 100 in which systems and/or method, described herein, may be implemented. The implementation environment 100 includes a UE (User equipment) 110, a service environment 120, and a network 130. The service environment 120 include one or more sub-environments 121. To illustrate this, FIG. 1 shows, for convenience, examples of a 1st sub-environment 121-1, a 2nd sub-environment 121-2, and an N-th sub-environment 121-N (where N is any natural number).

The UE 110 is connected to the network 130, and the network 130 is connected to the service environment 120. The connections may be wired, wireless, or a combination of both wired and wireless. The UE 110 and the service environment 120 are connected via the network 130.

The UE 110 is a device that communicates with the service environment 120. The UE 110 receives information from the service environment 120 and/or sends information to the service environment 120. Also, the UE 110 may generate and/or store information to be transmitted, as necessary. Also, the UE 110 may store and/or process information that is received, as necessary.

The example FIG. 1 refers to the “UE”. However, it should be understood by those skilled in the art that general terms such as “user device,” “terminal,” “terminal device,” “communication device,” and “communication terminal” can be used interchangeably with the term “UE.”

For example, the UE 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 120 is an environment that communicates with the UE 110 to provide one or more services. The service environment 120 receives information from the UE 110 and/or sends information to the UE 110. Also, the service environment 120 may generate and/or store information to be transmitted, as necessary. Also, the service environment 120 may store and/or process information that is received, as necessary. For example, the service environment 120 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 1 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 120 is not specifically limited and can be adjusted according to the embodiments. For example, the services may include a service that provides information to the UE 110, a service that stores information from the UE 110, or a service that performs processing based on information from the UE 110 and returns the results of the processing.

In an embodiment, the Service Environments 120 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 120 includes one or more devices, such as servers and network devices, which provide services or perform processes. The placement of these devices within the service environment 120 can be determined as appropriate. Additionally, if the service environment 120 includes one or more sub-environments 121, the placement of devices can be determined based on predetermined policies for each sub-environment 121. For example, devices related to the first service may be placed in the 1st sub-environment 121-1, and devices related to the second service may be placed in the 2nd sub-environment 121-2. In another example, devices expected to have a higher load than a predetermined threshold may be placed in the 1st sub-environment 121-1, while devices expected to have a lower load than the predetermined threshold may be placed in the 2nd sub-environment 121-2. In this way, specific devices can be placed in specific sub-environments 121. Conversely, each sub-environment 121 can be specialized for a particular purpose.

In an embodiment, all processes executed in a single service may run within a single service environment, or in multiple service environments. Multiple processes executed in a single service could be provided by different service environments.

The network 130 is a network that exchanges information between the UE 110 and the service environment 120. The network 130 includes one or more wired and/or wireless networks.

For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 130 can be a part of a network. For example, in a 5G network that includes a RAN, a transport network, and a core network, the network 130 can be at least one of the RAN, the transport network, or the core network. For example, the service environment 120 could be in the core network, in which case the network 130 could correspond to a network that is a combination of a RAN and a transport network and is part of the 5G network.

The number and arrangement of devices and networks shown in FIG. 1 are provided as an example. It should be understood that any changes that may be implemented by those skilled in the art, such as the addition or rearrangement of well-known devices or networks at the time of implementation, are included in this disclosure.

The implementation environment 100 illustrated in FIG. 1 is now further described.

The implementation environment 100 illustrated in FIG. 1 includes a service environment 120a and a service environment 120b as the above-mentioned service environment 120, and a network 130a and a network 130b as the above-mentioned network 130. As illustrated in FIG. 1, the network 130a and the network 130b may be connected to each other.

The service environment 120a includes one or more sub-environments 121a. To illustrate this, for convenience, in FIG. 1, a 1st sub-environment 121a-1, a 2nd sub-environment 121a-2, and an N-th sub-environment 121a-N (where N is any natural number) are illustrated as an example. The service environment 120b includes one or more sub-environments 121b. To illustrate this, for convenience, in FIG. 1, a 1st sub-environment 121b-1, a 2nd sub-environment 121b-2, and an N-th sub-environment 121b-N (where N is any natural number) are illustrated as an example. The sub-environments 121a and the sub-environments 121b each correspond to the above-mentioned sub-environment 121.

UEs 110 capable of using a wireless communication service provided in a region (for example, a country) 140a are connected to the network 130a. The network 130a is connected to the service environment 120a. The UEs 110 capable of using the wireless communication service provided in the region 140a communicate with the service environment 120a via the network 130a.

Further, UEs 110 which use a wireless communication service provided in a region (for example, a country) 140b are connected to the network 130b. The network 130b is connected to the service environment 120b. The UEs 110 which use the wireless communication service provided in the region 140b communicate with the service environment 120b via the network 130b.

It is assumed that the region 140a and the region 140b are adjacent to each other via a boundary line (for example, a national border) 142.

As illustrated in FIG. 1, a UE 110aa, a UE 110ab, a UE 110ac, and a UE 110b are illustrated as UEs 110 included in the implementation environment 100 in at least one embodiment of the present disclosure.

It is assumed that the UE 110aa, the UE 110ab, and the UE 110ac can use the wireless communication service provided in the region 140a, and the UE 110b can use the wireless communication service provided in the region 140b. In addition, it is assumed that the UEs 110 in the at least one embodiment include a subscriber identity module (SIM) (eSIM or physical SIM).

Further, it is assumed that the UE 110aa is within a range of a cell 148a, which is the communication range (coverage) of a ground antenna 146a included in a ground communication facility 144a in the region 140a, and communicates with the service environment 120a via the ground antenna 146a, the ground communication facility 144a, and the network 130a.

It is assumed that the UE 110ab is within a range of a cell 148c, which is the communication range of the satellite 150, and communicates with the service environment 120a via the satellite 150, a terrestrial gateway device 152, and the network 130a. The gateway device 152 is, for example, a device that relays wireless communication, and in the at least one embodiment, for example, communication between the UE 110ab and the network 130a is relayed by the satellite 150 and the gateway device 152. It is noted that the UE 110ab is not within the range of the cell 148a, and thus the UE 110ab cannot perform wireless communication via the ground antenna 146a and the ground communication facility 144a.

The UE 110ac is located inside the region 140b, beyond the boundary line 142. Thus, in the situation illustrated in FIG. 1, the UE 110ac cannot use the wireless communication service provided in the region 140a.

The UE 110b is within the range of the cell 148b, which is the communication range of the ground antenna 146b included in the ground communication facility 144b in the region 140b, and the UE 110b communicates with the service environment 120b via the ground antenna 146b, the ground communication facility 144b, and the network 130b.

It is assumed that the UEs 110 in the at least one embodiment are terminals capable of wireless communication both via the ground antenna 146 and via the satellite 150.

Further, in the at least one embodiment, for example, wireless communication via the satellite 150 is performed by using the same protocol as that of wireless communication via the ground antenna 146. Thus, the UEs 110 that can use the wireless communication service provided in the region 140a can receive the same wireless communication service provided in the region 140a, whether through wireless communication via the ground antenna 146a or through wireless communication via the satellite 150.

Management of radio waves is carried out separately in each region, for example, in each country, and hence there is a possibility that a part or all of the frequency bands used in wireless communication via the satellite 150, which covers at least a part of the region 140a illustrated in FIG. 1, may overlap the frequency bands used in wireless communication via the ground antenna 146b, which covers at least a part of the region 140b.

Even in such a case, as illustrated in FIG. 1, when the UE 110ac happens to be located within the region 140b, the UE 110ac is located outside the cell 148c, which is the communication range of the satellite 150, and therefore wireless communication performed via the ground antenna 146b (for example, wireless communication performed by the UE 110b) is not affected by the UE 110ac.

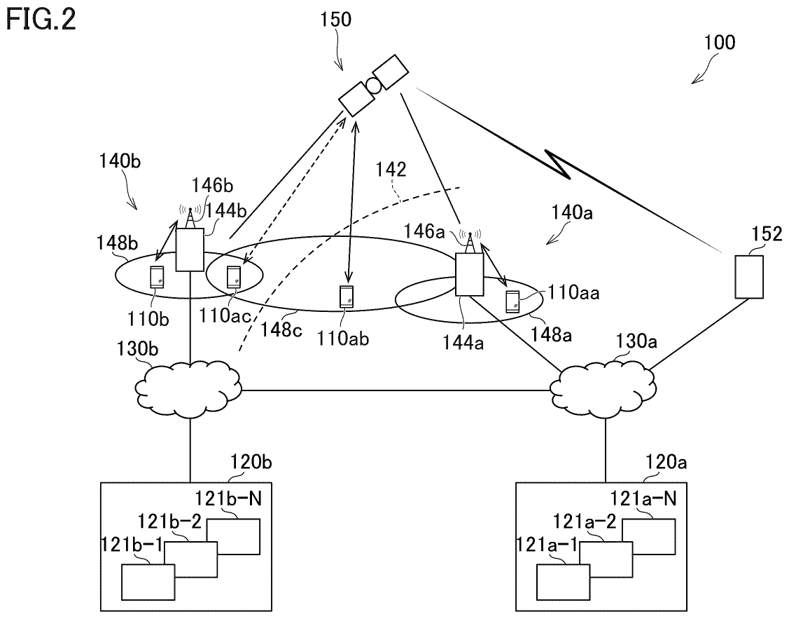

However, as illustrated in FIG. 2, there are cases in which the broadcast signal transmitted from the satellite 150 reaches the region 140b. In the situation, when the UE 110ac transmits radio waves in response to the broadcast signal, those radio waves may interfere with the radio waves relating to the wireless communication performed via the ground antenna 146b.

In consideration of the possibility, in the at least one embodiment, the following method is used to prevent radio wave interference caused by radio waves in a frequency band used for wireless communication via the satellite 150 being transmitted from a UE 110.

In the following description, it is assumed that the public land mobile network (PLMN) included in the broadcast signal (for example, system information block (SIB) 1) transmitted from the ground antenna 146a, the PLMN included in the broadcast signal transmitted from the satellite 150, and the PLMN included in the broadcast signal transmitted from the ground antenna 146b are different from one another.

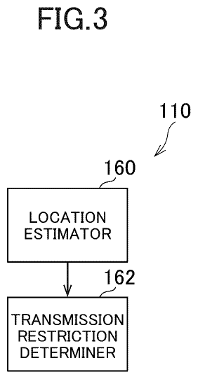

FIG. 3 is a functional block diagram for illustrating an example of functions implemented in a UE 110 in the at least one embodiment of the present disclosure. It is not required for all of the functions illustrated in FIG. 3 to be implemented in the UEs 110 in the at least one embodiment, and functions other than those illustrated in FIG. 3 may be implemented in the UEs 110.

As illustrated in FIG. 3, the UEs 110 in the at least one embodiment functionally include, for example, a location estimator 160 and a transmission restriction determiner 162.

The functions illustrated in FIG. 3 may be implemented by executing, by a processor included in the UE 110, a program that is installed in the UE 110, and that includes instructions corresponding to the functions. The program may be supplied to the UE 110 via a computer-readable information storage medium, such as an optical disc, a magnetic disk, a magnetic tape, a magneto-optical disc, a flash memory, or the like, or via the Internet or the like. The functions illustrated in FIG. 3 may also be implemented by a circuit block, a memory, and other LSIs. Further, a person skilled in the art would understand that the functions illustrated in FIG. 3 can be implemented in various forms by only hardware, by only software, or by a combination of hardware and software. Further, the functions illustrated in FIG. 3 may be implemented as one function of system software (for example, an operating system (OS)) installed in the UE 110. Further, the functions illustrated in FIG. 3 may be implemented by an application program installed in the UE 110.

In the at least one embodiment, the location estimator 160 included in the UE 110 estimates the location of the UE 110 without transmitting radio waves in the frequency band used for wireless communication via the satellite 150, for example.

The UE 110 may include a positioning receiver, such as a global positioning system (GPS) receiver or a global navigation satellite system (GNSS) receiver, which receives a positioning signal. The positioning receiver may be capable of receiving a regional navigation satellite system (RNSS) signal.

Then, the location estimator 160 included in the UE 110 may estimate the location of the UE 110 based on the positioning signal received by the positioning receiver. For example, the location estimator 160 may estimate a geographic location of the UE 110, such as the latitude and the longitude at which the UE 110 is located.

In the at least one embodiment, the transmission restriction determiner 162 included in the UE 110 determines whether or not to restrict transmission of radio waves in the frequency band used for wireless communication via the satellite 150 based on, for example, whether or not the estimated location is within an area in which wireless communication via the satellite 150 is permitted.

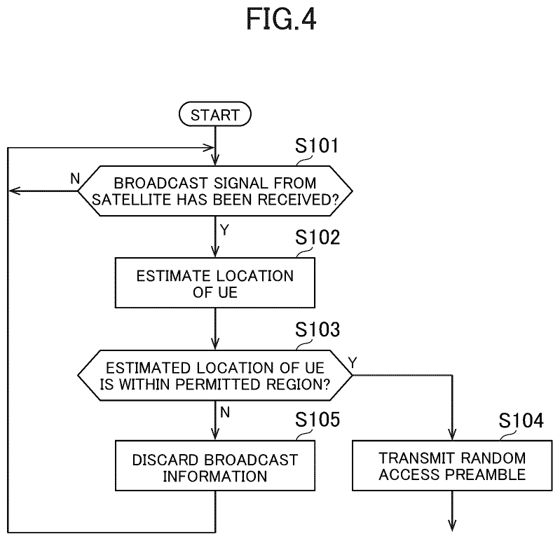

An example of a flow of processes performed by the UE 110 illustrated in FIG. 3 is now described with reference to a flowchart illustrated as an example in FIG. 4.

First, the UE 110, which is in a radio resource control (RRC) idle state, waits to receive a broadcast signal (for example, an SIB) from the satellite 150 (Step S101).

When the UE 110 receives a broadcast signal, the location estimator 160 estimates the location of the UE 110 (Step S102). Here, for example, the latitude and the longitude of the UE 110 are estimated.

Then, the transmission restriction determiner 162 determines whether or not the location of the UE 110 estimated in the process step of Step S102 is within a given permitted region (Step S103). For example, permitted area data indicating a condition of a combination of latitude and longitude under which wireless communication via the satellite 150 is permitted may be stored in advance in the transmission restriction determiner 162. In the process step of Step S103, the transmission restriction determiner 162 may determine, based on the location of the UE 110 estimated in the process step of S102 and the permitted area data, whether or not the location of the UE 110 estimated in the process step of Step S102 is a location that satisfies the condition indicated by the permitted area data.

In the process step of Step S103, when it is determined that the location of the UE 110 estimated in the process step of Step S102 is within the given permitted region (Step S103: Y), the UE 110 transmits a random access preamble (RACH preamble) (Step S104). After that, a process for establishing a connection between the UE 110 and the base station (eNodeB) is then executed.

Meanwhile, in the process step of Step S103, when it is determined that the location of the UE 110 estimated in the process step of Step S102 is not within the permitted region (Step S103: N), the transmission restriction determiner 162 discards the broadcast information indicated by the broadcast signal received in the process step of Step S101 (Step S105), and the process returns to the process step of Step S101. In this case, transmission of radio waves in the frequency band used for wireless communication via the satellite 150 is restricted.

As described above, in the at least one embodiment, the location estimator 160 included in the UE 110 may estimate the location of the UE 110 in response to reception of a broadcast signal from the satellite 150.

In addition, the transmission restriction determiner 162 may determine whether or not to restrict transmission of a random access preamble in response to reception of the broadcast signal from the satellite 150.

For example, there may be a case in which, when the UE 110ac illustrated in FIG. 2 is in an RRC idle state, the UE 110ac receives an SIB from the satellite 150, and it is determined that the location of the UE 110ac is not within the region 140a. In this case, the UE 110ac may restrict transmission of radio waves in the frequency band used for wireless communication via the satellite 150.

Meanwhile, there may be a case in which, when the UE 110ab illustrated in FIG. 2 is in an RRC idle state, the UE 110ab receives an SIB from the satellite 150, and it is determined that the location of the UE 110ab is located within the region 140a. In this case, the UE 110ab may transmit a random access preamble, which consists of radio waves in the frequency band used for wireless communication via the satellite 150. In this case, transmission of radio waves in the frequency band used for wireless communication via the satellite 150 is not restricted.

In the at least one embodiment, whether or not transmission of radio waves in the frequency band used for wireless communication via the satellite 150 is restricted is determined based on whether or not the estimated location of the UE 110 is within an area in which wireless communication via the satellite 150 is permitted. For example, when it is determined that the UE 110ac is located within the region 140b, the UE 110ac is restricted from transmitting radio waves in the frequency band used for wireless communication via the satellite 150. Thus, even when a part or all of the frequency bands used in wireless communication via the satellite 150 and wireless communication via the ground antenna 146b overlap, wireless communication via the ground antenna 146b (for example, communication between the UE 110b and the service environment 120b via the ground antenna 146b) is not affected by the UE 110ac.

In this way, in the at least one embodiment, it is possible to prevent radio wave interference caused by radio waves in the frequency band used for wireless communication via the satellite 150 being transmitted from a UE 110.

Further, when a method of restricting wireless communication via the satellite 150 by the UE 110ac by rejecting authentication of the UE 110ac by the core network or the base station is adopted, it is not possible to prevent radio waves for authentication from being transmitted from the UE 110ac. Meanwhile, in the at least one embodiment, in a situation in which transmission of radio waves in the frequency band used for wireless communication via the satellite 150 is restricted, such radio waves for authentication are not transmitted from the UE 110ac.

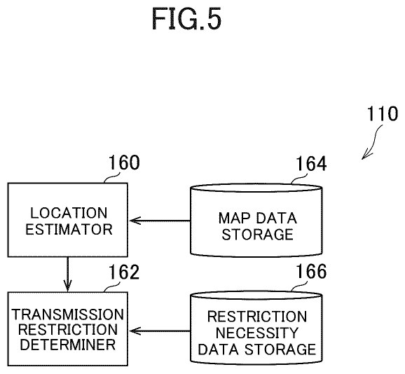

As illustrated in FIG. 5, the UE 110 in the at least one embodiment may include a map data storage 164 and a restriction necessity data storage 166 in addition to the functional blocks illustrated in FIG. 3.

In the at least one embodiment, the map data storage 164 stores, for example, map data indicating a geographic range of each of a plurality of regions. The map data may indicate a region code of each of the plurality of regions.

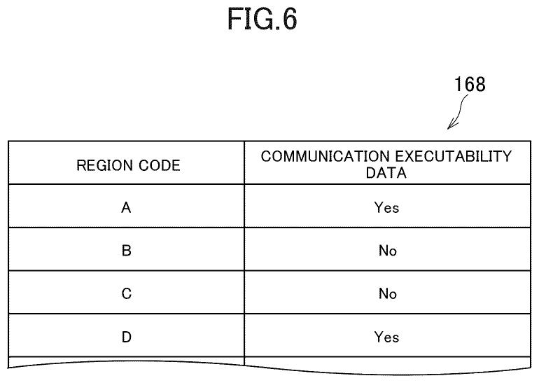

In the at least one embodiment, the restriction necessity data storage 166 stores, for example, restriction necessity data 168 shown as an example in FIG. 6. The restriction necessity data 168 includes, for example, a region code and communication executability data. Four pieces of restriction necessity data 168 are shown as an example in FIG. 6.

The transmission restriction determiner 162 may determine whether or not to restrict transmission of radio waves in the frequency band used for wireless communication via the satellite 150 based on the estimated location and the restriction necessity data 168 indicating whether restriction on transmission of radio waves is required for each of at least one region.

For example, in the process step of Step S103 of FIG. 4, the transmission restriction determiner 162 may identify, based on map data, a region code of the region to which the location of the UE 110 estimated in the process step of Step S102 of FIG. 4 belongs. Further, the transmission restriction determiner 162 may identify the restriction necessity data 168 including the identified region code. Further, the transmission restriction determiner 162 may identify the value of the communication executability data included in the identified restriction necessity data 168.

Then, when the value of the identified communication executability data is “Yes,” the transmission restriction determiner 162 may determine that the location of the UE 110 estimated in the process step of Step S102 is within the permitted region. Meanwhile, when the value of the identified communication executability data is “No,” the transmission restriction determiner 162 may determine that the location of the UE 110 estimated in the process step of Step S102 is not within the permitted region.

The restriction necessity data 168 may be included in a broadcast signal (for example, an SIB) transmitted from the satellite 150. In this case, the transmission restriction determiner 162 may determine whether or not to restrict transmission of radio waves in the frequency band used for wireless communication via the satellite 150 based on the restriction necessity data 168 included in the broadcast signal received from the satellite 150.

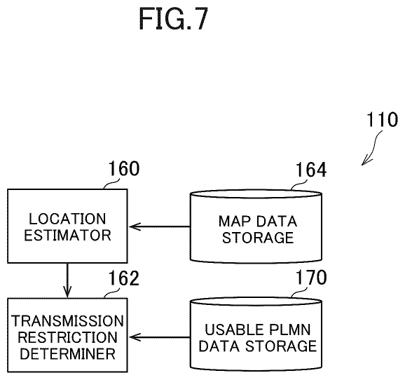

Further, as illustrated in FIG. 7, the UE 110 in the at least one embodiment may include the map data storage 164 and a usable PLMN data storage 170 in addition to the functional blocks illustrated in FIG. 3.

The map data storage 164 illustrated in FIG. 7 is the same as the map data storage 164 illustrated in FIG. 5. The map data storage 164 has been described with reference to FIG. 5, and hence description of the map data storage 164 illustrated in FIG. 7 is omitted here.

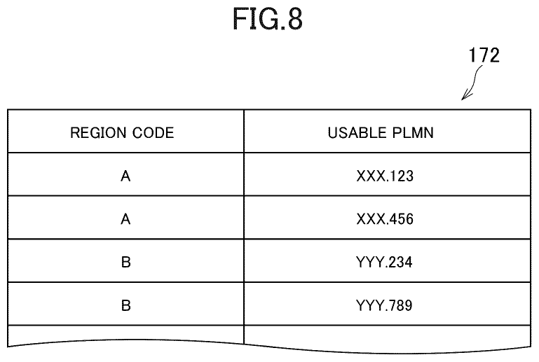

In the at least one embodiment, the usable PLMN data storage 170 stores at least one piece of usable PLMN data 172 shown as an example in FIG. 8 indicating, for example, a PLMN usable by the UE 110 and the region corresponding to the PLMN. The usable PLMN data 172 shown in FIG. 8 includes, for example, a region code and a usable PLMN. Four pieces of usable PLMN data 172 are shown as an example in FIG. 8.

The transmission restriction determiner 162 may determine, when a PLMN included in a broadcast signal received from the satellite 150 is indicated in any piece of usable PLMN data 172, whether or not to restrict transmission of radio waves in the frequency band used for wireless communication via the satellite 150 based on the region associated with the PLMN in the piece of usable PLMN data 172 and the estimated location.

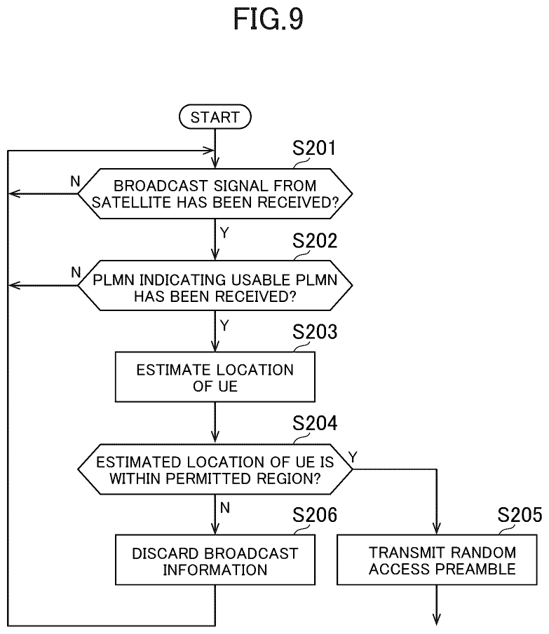

Another example of a flow of processes performed by the UE 110 illustrated in FIG. 7 is now described with reference to a flowchart illustrated as an example in FIG. 9.

The process steps of Step S201, Step S203, Step S205, and Step S206 of FIG. 9 are the same as the process steps of Step S101, Step S102, Step S104, and Step S105, respectively, described with reference to FIG. 4, and hence description thereof is omitted here.

For example, when a UE 110 in an RRC idle state receives a broadcast signal from the satellite 150, the transmission restriction determiner 162 may determine whether or not a PLMN indicating a usable PLMN has been received in the process step of Step S201 (Step S202). For example, when the PLMN included in the received broadcast signal matches the usable PLMN included in any of the pieces of the usable PLMN data 172, the transmission restriction determiner 162 may determine that a PLMN indicating a usable PLMN has been received in the process step of Step S201. Further, in this case, the transmission restriction determiner 162 may identify the usable PLMN data 172 which includes the PLMN received in the process step of Step S201 as a usable PLMN.

When it is determined in the process step of Step S202 that a PLMN indicating a usable PLMN has been received in the process step of Step S201 (Step S202: Y), the process may advance to the process step of Step S203. Meanwhile, when it is not determined in the process step of Step S202 that a PLMN indicating a usable PLMN has been received in the process step of Step S201 (Step S202: N), the process may return to the process step of Step S201.

In the process step of Step S204, the transmission restriction determiner 162 may determine whether or not the region code of the region to which the location of the UE 110 estimated in the process step of Step S203 belongs is the region code associated with the identified piece of usable PLMN data 172.

When the region code of the region to which the location of the UE 110 estimated in the process step of Step S203 belongs is the region code associated with the identified piece of usable PLMN data 172, the transmission restriction determiner 162 may determine that the location of the UE 110 estimated in the process step of Step S203 is within the permitted region. Meanwhile, when the region code of the region to which the location of the UE 110 estimated in the process step of Step S203 belongs is not the region code associated with the identified piece of usable PLMN data 172, the transmission restriction determiner 162 may determine that the location of the UE 110 estimated in the process step of Step S203 is not within the permitted region.

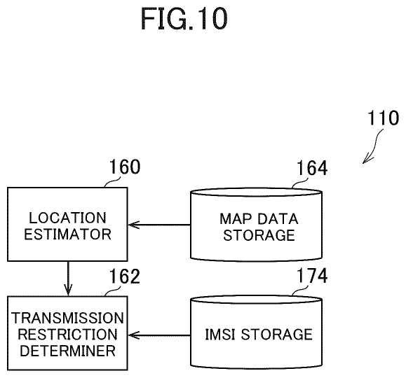

Further, as illustrated in FIG. 10, the UE 110 in at the least one embodiment may include a map data storage 164 and an international mobile subscriber identity (IMSI) storage 174 in addition to the functional blocks illustrated in FIG. 3.

The map data storage 164 illustrated in FIG. 10 stores, for example, map data indicating a geographic range of each of a plurality of countries. The map data may indicate a country code of each of the plurality of countries.

The IMSI storage 174 included in the UE 110 stores an IMSI of the UE 110.

In this case, the location estimator 160 may estimate the country in which the UE 110 is located based on the map data.

The transmission restriction determiner 162 determines whether or not to restrict the transmission of radio waves in the frequency band used for wireless communication via the satellite 150 based on the country code (for example, mobile country code (MCC)) indicated by the IMSI stored in the IMSI storage 174 and the estimated country.

For example, in the process step of Step S102 of FIG. 4, the location estimator 160 may estimate the country in which the UE 110 is located.

Then, in the process step of Step S103, when the country code of the country estimated in the process step of Step S102 matches the country code indicated by the IMSI stored in the IMSI storage 174, the transmission restriction determiner 162 may determine that the location of the UE 110 estimated in the process step of Step S102 is within a given permitted region.

Meanwhile, when the country code of the country estimated in the process step of Step S102 does not match the country code indicated by the IMSI stored in the IMSI storage 174, the transmission restriction determiner 162 may determine that the location of the UE 110 estimated in the process step of Step S102 is not within a given permitted region.

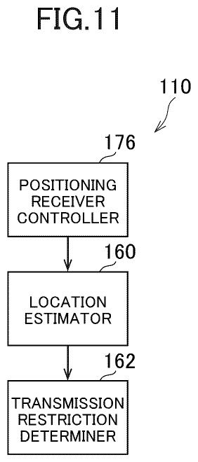

Further, as illustrated in FIG. 11, the UE 110 in at the least one embodiment may include a positioning receiver controller 176 in addition to the functional blocks illustrated in FIG. 3.

The positioning receiver controller 176 may activate the positioning receiver included in the UE 110 in response to reception of a broadcast signal from the satellite 150.

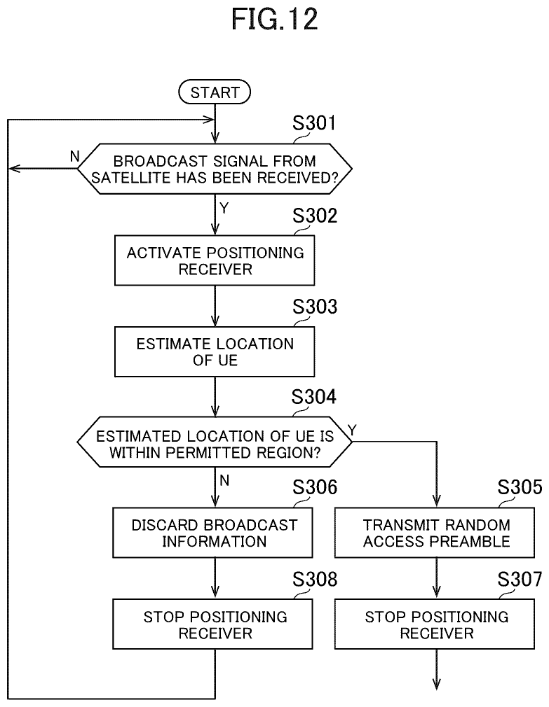

Another example of a flow of processes performed by the UE 110 illustrated in FIG. 11 is now described with reference to a flowchart illustrated as an example in FIG. 12.

The process steps of Step S301, Step S303, Step S304, Step S305, and Step S306 of FIG. 12 are the same as the process steps of Step S101, Step S102, Step S103, Step S104, and Step S105, respectively, described with reference to FIG. 4, and hence description thereof is omitted here.

In the process example, in the initial state, it is assumed that the positioning receiver included in the UE 110 is stopped.

For example, when a UE 110 in an RRC idle state receives a broadcast signal from the satellite 150, the positioning receiver controller 176 may activate the positioning receiver included in the UE 110 (Step S302). Then, in the process step of Step S303, the activated positioning receiver may estimate the geographical location of the UE 110.

Further, when the process step of Step S305 is complete, the positioning receiver controller 176 may stop the positioning receiver included in the UE 110 (Step S307). Further, when the process step of Step S306 is complete, the positioning receiver controller 176 may stop the positioning receiver included in the UE 110 (Step S308).

In the UE 110 described above, for a predetermined duration after transmission of radio waves in the frequency band used for wireless communication via the satellite 150 is restricted based on the estimated location of the UE 110, the transmission restriction determiner 162 may restrict transmission of radio waves in the frequency band used for wireless communication via the satellite 150 without estimating the location of the UE 110 even when a broadcast signal is received from the satellite 150.

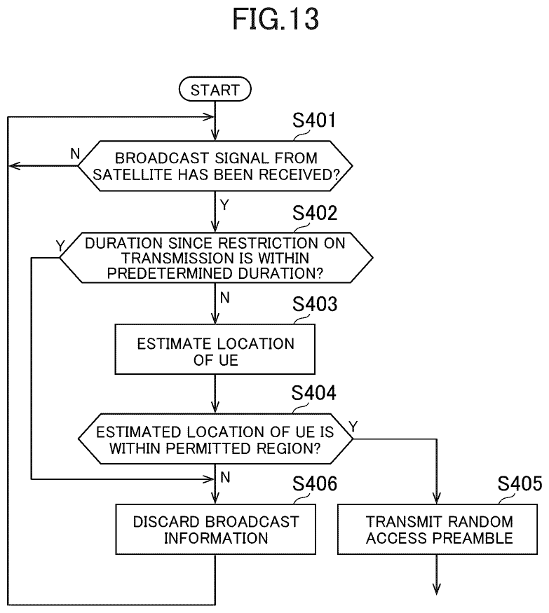

FIG. 13 is a flowchart for illustrating an example of a flow of processes performed by the UE 110 in this example.

The process steps of Step S401, Step S403, Step S404, Step S405, and Step S406 of FIG. 13 are the same as the process steps of Step S101, Step S102, Step S103, Step S104, and Step S105, respectively, described with reference to FIG. 4, and hence description thereof is omitted here.

For example, when a UE 110 in an RRC idle state receives a broadcast signal from the satellite 150, the transmission restriction determiner 162 may check whether or not the duration since the restriction on transmission of radio waves in the frequency band used for wireless communication via the satellite 150 is within a predetermined duration (for example, one day) (Step S402).

Then, when it is confirmed that the duration since the restriction on transmission of radio waves in the frequency band used for wireless communication via the satellite 150 is within the predetermined duration (Step S402: Yes), the transmission restriction determiner 162 may discard the broadcast information indicated by the broadcast signal received in the process step of Step S401 without estimating the location of the UE 110 (Step S406), and return the process to Step S401.

When it is confirmed that the duration since the restriction on transmission of radio waves in the frequency band used for wireless communication via the satellite 150 is longer than the predetermined duration, or that transmission of radio waves in the frequency band used for wireless communication via satellite 150 is not restricted (Step S402: N), the process step of Step S403 and subsequent steps may be executed.

In this way, power consumption can be reduced more than in a case in which the positioning receiver is kept activated at all times.

Further, in the at least one embodiment, it is not required that the location estimator 160 estimate the location of the UE 110 based on a positioning signal received by the positioning receiver. In addition, it is not required that the UE 110 include a positioning receiver.

For example, the location estimator 160 may estimate the country in which the UE 110 is located based on a country code indicated by a broadcast signal received from the ground antenna 146. Further, the transmission restriction determiner 162 may determine whether or not to restrict transmission of radio waves in the frequency band used for wireless communication via the satellite 150 based on the estimated country.

For example, in the process step of Step S102 of FIG. 4, the location estimator 160 may identify a country code (for example, MCC) indicated by the PLMN included in a broadcast signal (for example, SIB 1) received from the ground antenna 146.

Then, in the process step of Step S103 of FIG. 4, the transmission restriction determiner 162 may determine whether or not the country code identified in the process step of Step S102 is the country code of a given country. For example, when the UE 110 includes the IMSI storage 174, the transmission restriction determiner 162 may determine whether or not the country code identified in the process step of Step S102 matches the country code indicated by the IMSI stored in the IMSI storage 174.

When the country code identified in the process step of Step S102 is the country code of the given country, the transmission restriction determiner 162 may determine that the location of the UE 110 estimated in the process step of Step S102 is within the permitted region. Meanwhile, when the country code identified in the process step of Step S102 is not the country code of the given country, the transmission restriction determiner 162 may determine that the location of the UE 110 estimated in the process step of Step S102 is not within the permitted region.

The above-mentioned process may be executed when a signal strength of the broadcast signal received from the ground antenna 146 is weaker than the signal strength of the broadcast signal received from the satellite 150.

In this way, radio wave interference caused by a terminal transmitting radio waves in the frequency band used for wireless communication via the satellite can be prevented without using a positioning receiver.

Further, in the at least one embodiment, the location estimator 160 may estimate the location of the UE 110 based on the strength of the broadcast signal received from each of a plurality of ground antennas 146.

For example, antenna location information indicating the geographic location (for example, latitude and longitude) of each of a plurality of ground antennas 146 may be stored in the location estimator 160.

Further, the location estimator 160 may estimate the geographic location of the UE 110 based on the strength of the broadcast signal received from each of a plurality of ground antennas 146 by using existing location estimation technology, such as triangulation using a received signal strength indicator (RSSI).

In addition, for example, when the signal strength of the broadcast signal received from the ground antenna 146b in the region 140b is stronger than the signal strength of the broadcast signal received from the ground antenna 146a in the region 140a, the location estimator 160 may estimate that the UE 110 is located in the region 140b. Conversely, when the signal strength of the broadcast signal received from the ground antenna 146a in the region 140a is stronger than the signal strength of the broadcast signal received from the ground antenna 146b in the region 140b, for example, the location estimator 160 may estimate that the UE 110 is located in the region 140a.

Further, as described above, the transmission restriction determiner 162 may determine whether or not to restrict transmission of radio waves in the frequency band used for wireless communication via the satellite 150 based on whether or not the location of the UE 110 estimated in this way is within an area in which wireless communication via the satellite 150 is permitted.

The above-mentioned process may be executed when the signal strength of the broadcast signal received from the satellite 150 is stronger than the signal strength of the broadcast signal received from any of the ground antennas 146.

In this way, radio wave interference caused by a terminal transmitting radio waves in the frequency band used for wireless communication via the satellite can be prevented without using a positioning receiver.

Further, in the at least one embodiment, regarding emergency calls, it is not required to estimate the location of the UE 110 by using the location estimator 160 as described above, or to restrict the transmission of radio waves by using the transmission restriction determiner 162, and radio waves may be transmitted in the frequency band used for wireless communication via the satellite 150 (for example, a random access preamble) from the UE 110.

Further, when the UE 110 in the at least one embodiment receives broadcast signals from a plurality of transmission sources (for example, the ground antenna 146 and the satellite 150), the UE 110 may determine a transmission source of a response candidate in accordance with a predetermined priority order. Alternatively, the UE 110 may determine the transmission source of the broadcast signal having the highest signal strength as the transmission source of the response candidate. Then, when the transmission source of the response candidate is the satellite 150, the above-mentioned processes may be executed.

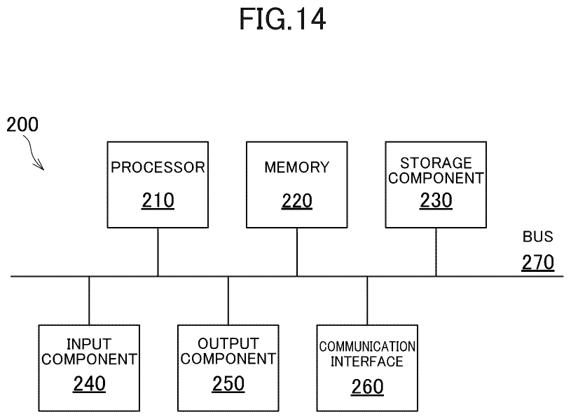

FIG. 14 illustrates an embodiment of a device 200 which is a UE 110. As shown in FIG. 14, the device 200 includes processor 210, a memory 220, a storage component 230, an input component 240, an output component 250, a communication interface 260, and a bus 270.

The processor 210, as used herein, means any type of computational circuit that may comprise hardware elements and software elements. The processor 210 may be embodied as a multi-core processor, a single core processor, or a combination of one or more multi-core processors and/or one or more single core processors, a distributed processing system, or the like. The processor 210 may be a Central Processing Unit (CPU), a graphics processing unit (GPU), an accelerated processing unit (APU), an application-specific integrated circuit (ASIC), or another type of processing component.

Memory 220 includes a non-transitory computer readable medium. Memory 220 includes a random-access memory (RAM), a read only memory (ROM), and/or another type of dynamic or static storage device (e.g., a flash memory, a magnetic memory, and/or an optical memory) that stores information and/or instructions for use by processor 210. The memory 220 comprises machine-readable instructions which are executable by the processor 210. These machine-readable instructions when executed by the processor 210 cause the processor 210 to perform one or more method steps of an embodiment described above.

Storage component 230 stores information and/or software related to the operation and use of the device 200. For example, storage component 230 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 240 is configured to receive information, such as user input. For example, the input component 240 may include, but not be limited to, a touch screen display, a keyboard, a keypad, a mouse, a button, a switch, and/or a microphone. Additionally, or alternatively, the input component 240 may include a sensor for sensing information (e.g., a global positioning system (GPS), an accelerometer, a gyroscope, and/or an actuator).

Output component 250 is configured to provide output information from the device 200. For example, the output component 250 may be, but not limited to, a display, a speaker, an instruction device to an external device, and/or one or more light-emitting diodes (LEDs).

Communication interface 260 is an interface that provides a communication connection to other devices, such as external devices and internal devices. The connection by the communication interface 260 can be a wired connection, a wireless connection, or a combination of wired and wireless connections, and can be a direct connection or an indirect connection via a communication network that exists between the device 200 and other devices. In other words, the standard of the communication interface 260 is not limited.

The bus 270 acts as an interconnect between the processor 210, the memory 220, the storage component 230, the input component 240, the output component 250, and the communication interface 260 of the device 200. The bus 270 may include a wired interconnection or a wireless interconnection.

The number and arrangement of components shown in FIG. 14 are provided as an example. In practice, device 200 may include additional components, fewer components, different components, or differently arranged components than those shown in FIG. 14. Additionally, or alternatively, a set of components (e.g., one or more components) of device 200 may perform one or more functions described as being performed by another set of components of device 200. Further, one or more method steps described in any of the embodiments may be performed utilizing a plurality of devices 200 in communication with one another.

The positioning receiver may be included in the input component 240.

The technology described in the present disclosure can also be expressed as follows.
[1] A terminal which performs wireless communication via a satellite, the terminal including:
location estimation means for estimating a location of the terminal without transmitting radio waves in a frequency band used for wireless communication via the satellite; and
transmission restriction determination means for determining whether to restrict transmission of radio waves in the frequency band used for wireless communication via the satellite based on whether the estimated location is within an area in which wireless communication via the satellite is permitted.
[2] The terminal according to Item [1], further including a positioning receiver,
wherein the location estimation means is configured to estimate the location of the terminal based on a positioning signal received by the positioning receiver.
[3] The terminal according to Item [2], further including positioning receiver control means for activating the positioning receiver in response to reception of a broadcast signal from the satellite.
[4] The terminal according to Item [1],
wherein the location estimation means is configured to estimate a country in which the terminal is located based on a country code indicated by a broadcast signal received from a ground antenna, and
wherein the transmission restriction determination means is configured to determine whether to restrict transmission of radio waves in the frequency band used for wireless communication via the satellite based on the estimated country.
[5] The terminal according to Item [1], wherein the location estimation means is configured to estimate the location of the terminal based on a strength of a broadcast signal received from each of a plurality of ground antennas.
[6] terminal according to any one of Items [1] to [5], wherein the transmission restriction determination means is configured to determine whether to restrict transmission of radio waves in the frequency band used for wireless communication via the satellite based on the estimated location and restriction necessity data indicating whether restriction on transmission of radio waves is required for each of at least one region.
[7] The terminal according to Item [6], further including restriction necessity data storage means for storing the restriction necessity data.
[8] The terminal according to Item [6], wherein the restriction necessity data is data included in a broadcast signal received from the satellite.
[9] The terminal according to any one of Items [1] to [5], further including usable PLMN data storage means for storing at least one piece of usable public land mobile network (PLMN) data indicating a PLMN usable by the terminal and a region corresponding to the PLMN,
wherein the transmission restriction determination means is configured to determine, when a PLMN included in a broadcast signal received from the satellite is indicated in any piece of usable PLMN data, whether to restrict transmission of radio waves in the frequency band used for wireless communication via the satellite based on a region associated with the PLMN in the piece of usable PLMN data and the estimated location.
[10] The terminal according to any one of Items [1] to [5], further including an IMSI storage means for storing an international mobile subscriber identity (IMSI),
wherein the location estimation means is configured to estimate a country in which the terminal is located, and
wherein the transmission restriction determination means is configured to determine whether to restrict transmission of radio waves in the frequency band used for wireless communication via the satellite based on a country code indicated by the IMSI and the estimated country.
[11] The terminal according to any one of Items [1] to [10], wherein the location estimation means is configured to estimate the location of the terminal in response to reception of a broadcast signal from the satellite.
[12] The terminal according to any one of Items [1] to [11], wherein the transmission restriction determination means is configured to restrict, for a predetermined duration after transmission of radio waves in the frequency band used for wireless communication via the satellite is restricted based on the estimated location, transmission of radio waves in the frequency band used for wireless communication via the satellite without estimating the location of the terminal even when a broadcast signal is received from the satellite.
[13] The terminal according to any one of Items [1] to [12], wherein the transmission restriction determination means is configured to determine whether to restrict transmission of a random access preamble in response to reception of a broadcast signal from the satellite.
[14] A transmission control method, including:
estimating, by a terminal which performs wireless communication via a satellite, a location of the terminal without transmitting radio waves in a frequency band used for wireless communication via the satellite; and
determining, by the terminal, whether to restrict transmission of radio waves in the frequency band used for wireless communication via the satellite based on whether the estimated location is within an area in which wireless communication via the satellite is permitted.
[15] A program for causing a terminal, which is a computer, to:
estimate a location of the terminal which performs wireless communication via a satellite, without transmitting radio waves in a frequency band used for wireless communication via the satellite; and
determine whether to restrict transmission of radio waves in the frequency band used for wireless communication via the satellite based on whether the estimated location is within an area in which wireless communication via the satellite is permitted.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A terminal which performs wireless communication via a satellite, and which executes:
a location estimation process of estimating a location of the terminal without transmitting radio waves in a frequency band used for wireless communication via the satellite; and
a transmission restriction determination process of determining whether to restrict transmission of radio waves in the frequency band used for wireless communication via the satellite based on whether the estimated location is within an area in which wireless communication via the satellite is permitted.

2. The terminal according to claim 1, further comprising a positioning receiver,
wherein the location estimation process includes estimating the location of the terminal based on a positioning signal received by the positioning receiver.

3. The terminal according to claim 2, wherein the terminal further executes a positioning receiver activation process of activating the positioning receiver in response to reception of a broadcast signal from the satellite.

4. The terminal according to claim 1,
wherein the location estimation process includes estimating a country in which the terminal is located based on a country code indicated by a broadcast signal received from a ground antenna, and
wherein the transmission restriction determination process includes determining whether to restrict transmission of radio waves in the frequency band used for wireless communication via the satellite based on the estimated country.

5. The terminal according to claim 1, wherein the location estimation process includes estimating the location of the terminal based on a strength of a broadcast signal received from each of a plurality of ground antennas.

6. The terminal according to claim 1, wherein the transmission restriction determination process includes determining whether to restrict transmission of radio waves in the frequency band used for wireless communication via the satellite based on the estimated location and restriction necessity data indicating whether restriction on transmission of radio waves is required for each of at least one region.

7. The terminal according to claim 6, wherein the terminal stores the restriction necessity data.

8. The terminal according to claim 6, wherein the restriction necessity data is data included in a broadcast signal received from the satellite.

9. The terminal according to claim 1,
wherein the terminal stores at least one piece of usable public land mobile network (PLMN) data indicating a PLMN usable by the terminal and a region corresponding to the PLMN, and
wherein the transmission restriction determination process includes determining, when a PLMN included in a broadcast signal received from the satellite is indicated in any piece of usable PLMN data, whether to restrict transmission of radio waves in the frequency band used for wireless communication via the satellite based on a region associated with the PLMN in the piece of usable PLMN data and the estimated location.

10. The terminal according to claim 1,
wherein the terminal stores an international mobile subscriber identity (IMSI),
wherein the location estimation process includes estimating a country in which the terminal is located, and
wherein the transmission restriction determination process includes determining whether to restrict transmission of radio waves in the frequency band used for wireless communication via the satellite based on a country code indicated by the IMSI and the estimated country.

11. The terminal according to claim 1, wherein the location estimation process includes estimating the location of the terminal in response to reception of a broadcast signal from the satellite.

12. The terminal according to claim 11, wherein the transmission restriction determination process includes restricting, for a predetermined duration after transmission of radio waves in the frequency band used for wireless communication via the satellite is restricted based on the estimated location, transmission of radio waves in the frequency band used for wireless communication via the satellite without estimating the location of the terminal even when a broadcast signal is received from the satellite.

13. The terminal according to claim 1, wherein the transmission restriction determination process includes determining whether to restrict transmission of a random access preamble in response to reception of a broadcast signal from the satellite.

14. A transmission control method, comprising:
estimating, by a terminal which performs wireless communication via a satellite, a location of the terminal without transmitting radio waves in a frequency band used for wireless communication via the satellite; and
determining, by the terminal, whether to restrict transmission of radio waves in the frequency band used for wireless communication via the satellite based on whether the estimated location is within an area in which wireless communication via the satellite is permitted.

15. A non-transitory computer-readable information storage medium having stored thereon a program, the program causing a computer, which is a terminal, to:
estimate a location of the terminal which performs wireless communication via a satellite, without transmitting radio waves in a frequency band used for wireless communication via the satellite; and
determine whether to restrict transmission of radio waves in the frequency band used for wireless communication via the satellite based on whether the estimated location is within an area in which wireless communication via the satellite is permitted.
